(19) United States
(12) Patent Application Publication
(10) Pub. No.: US 2008/0004992 A1
(43) Pub. Date: Jan. 3, 2008

(54) Federated marketplace for electronic commerce

(75) Inventors: Brian M. King, Redmond, WA (US); Craig S. Bartholomew, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/480,226

(22) Filed: Jun. 30, 2006

(51) Int. Cl. G06F 17/30

(52) U.S. Cl. 705/27

(57) ABSTRACT

A federated marketplace provides a context-based environment for consumers to purchase products and services directly from an Internet-based search engine results page, without the need to navigate to the sponsoring merchant's Web site. Detailed descriptions of sponsoring merchants' products and services are presented directly within the search result Web page, for example, as a layer that may be activated by consumer indications of interest. Meta data identifying the sponsoring merchant's goods or services may be retrieved from the sponsoring merchant's Web site, either directly or by a search robot, and catalogued within the marketplace. A particular tagging schema may be used to provide Meta data identifying product data for retrieval. An immediate download of a product to a consumer may commence upon purchase.

### BACKGROUND

Search portals on the Internet today, for example, MSN Search, Yahoo, and Google, often present consumers using the search engines with a large, primary list of search results and a smaller, secondary list of sponsored links offering products or services that match the context of their search query. These sponsored links, when selected, require the user to navigate away from the search engine results to the Web site of the product or service sponsor. Often the user is required to navigate through the pages of this sponsor's Web site in order to learn more about a product or service or to purchase a desired item. This additional navigation takes time. Also the user has by now navigated away from the original search results, and must navigate back to the search results in other to utilize other links from the original result set.

In order to utilize existing “sponsored link” advertising scenarios promoted by a search engine portal to sell products, sponsors must also have at least an informative Web page about their products. In some cases, sponsors may have an entire electronic commerce experience as a destination for the “sponsored link” with the ability to conduct a transaction with, receive payment from, and perform order fulfillment for the consumer. Building, maintaining, and marketing an electronic commerce Web site requires a great amount of time, expense, and expertise. Even providing a simple, informational Web site may be a significant expense or technical challenge for some merchants who might otherwise benefit from purchasing a sponsored position in the context of certain search results.

### SUMMARY

A federated marketplace as described herein may be implemented as a convenient way for consumers to learn about and purchase products and services in a context-based environment, directly from an Internet-based search engine results page, without the need to navigate to the sponsoring merchant's Web site. Detailed descriptions of sponsoring merchants' products and services may be presented directly within the search result Web page, for example, as a layer that may be activated by consumer indications of interest. The sponsoring merchants may directly supply or input data about its products and services, which may be stored in a catalog database maintained by the search portal and indexed to a specific context, e.g., a set of search query terms. Meta data identifying the sponsoring merchant's goods or services may also be retrieved from the sponsoring merchant's Web site, either directly or by a search robot that identifies particular Meta tags associated with a description of the products and services. A particular tagging schema may be used to provide Meta data for retrieval and use in the federated marketplace environment.

The federated marketplace may also provide a point of sale from the Web site of the search engine portal, removing the need for the sponsoring merchant to provide a separate electronic commerce Web site for the consumer to visit after completing an Internet search. In some implementations wherein the product is a software program or digital data, e.g., music files, or locally on the servers that make up the point of sale ecommerce site. Alternately, the product may be stored remotely on Internet storage devices, e.g., servers, associated with the sponsoring merchant. In such a case of digital downloads, an immediate download of the product to a consumer may commence upon purchase.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

FIG. 1 is a schematic diagram of components in an implementation of a federated marketplace for electronic commerce.

FIG. 2 is a flow diagram of an implementation of operations for providing marketplace search results to a consumer and completing a product purchase transaction.

FIG. 3 is a schematic diagram of an exemplary Web page depicting a primary search result and a marketplace search result of products of sponsoring merchants for immediate purchase.

FIG. 4 is a schematic diagram of an exemplary Web page depicting a primary search result and a marketplace search result of products of sponsoring merchants, including a layered display of detailed product information.

FIG. 5 is a flow diagram of an implementation of operations for cataloguing product data within a federated marketplace.

FIG. 6 is a schematic diagram of several components involved in a robotic search for product data to store in a marketplace catalog.

FIG. 7 is a schematic diagram of a general purpose computing system for implementing aspects of the home entertainment environment.

### DETAILED DESCRIPTION

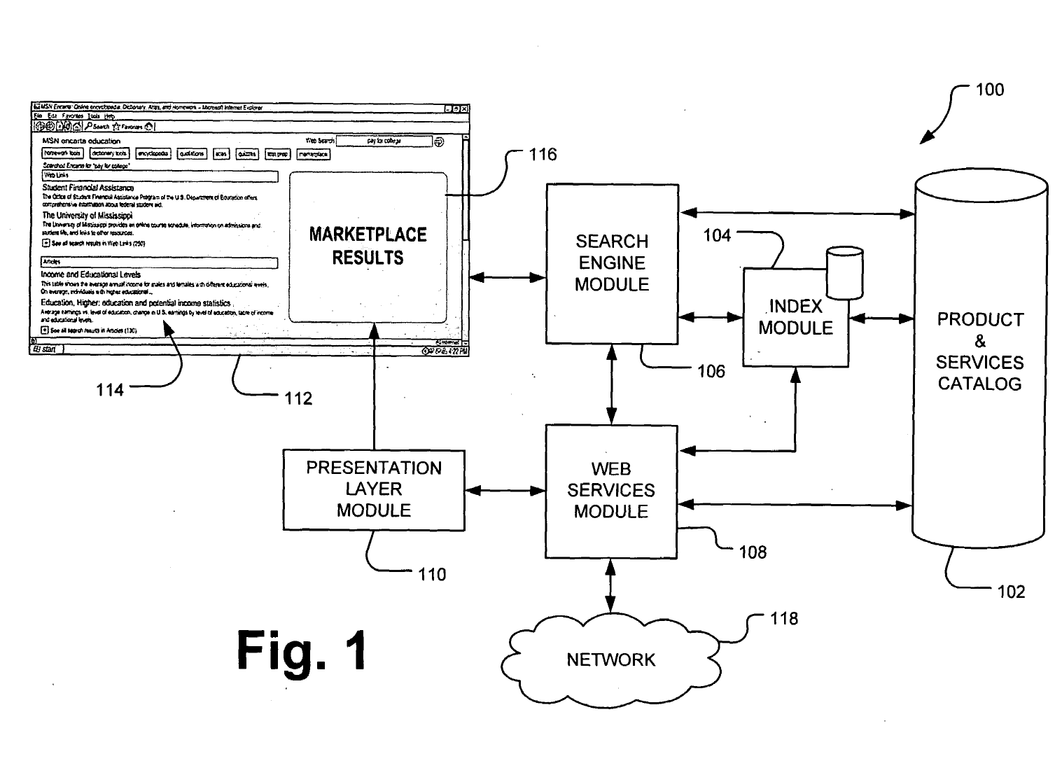

A federated marketplace may display actual products and services of a sponsoring merchant to a consumer in context with the search results on a search portal Web page. The federated marketplace may further provide a consumer with the ability to purchase directly form the search results Web page or learn more about the product without having to visit the Web site of the sponsoring merchant. FIG. 1 depicts exemplary logical components in a system 100 for implementing a federated marketplace 116 in conjunction with an Internet search portal 112. These components provide the search engine with context-based products or services of sponsoring merchants to display in conjunction with the primary search results 114.

A catalog 102 stores product and service identifications, related product and service descriptions, and locations of the products (if available for immediate fulfillment upon purchase). The catalog 102 may be populated with information gathered about a product or service from the sponsoring merchant. The catalog 102 may be populated via manual entry by the sponsoring merchant, e.g., via an interface provided by the search engine portal purveying the federated marketplace. Alternately, the catalog 102 may be populated by gathering product and service descriptions directly from a sponsoring merchant's Web site. The sponsoring merchant may tag information on its Web site describing the product or service with a unique identification framework, e.g., Meta data tags in conformance with a particular extensible mark-up language (XML) schema (described in greater detail further herein).

The system 100 may further include a context-based index module 104 that indexes the catalog 102 with possible keywords or search terms related to the products on the marketplace as requested by the sponsoring merchant. For example, a music publisher might request that digital music from an album be indexed to the artist's name, the album title, the song titles on the album, and the category of music in which the album may be classified. The product indexing may be automated based on the Meta data associated with specific products in the catalog 102. The assignment of Meta data with product information is described in further detail herein below. The index module 104 includes a database structure that stores the relationships between keywords and products and services in the catalog 102.

A search engine module 106 processes search requests for information, products, and services initiated by consumers using the search portal 112. The index module 104 is then consulted by the search engine module 106 during a search request to determine which products or services from which sponsoring merchants to present in the federated marketplace 116. The context-based index module 104 also stores relationships between search engine query strings entered by consumers and specific products offered by the sponsoring merchants and stored in the catalog 102. When a consumer enters a search query on a search engine page, the context-based index module 104 compares the terms in the search string to subject matter keywords associated with the products offered by the sponsoring merchants and returns a selection of related products or service offered by sponsoring merchants.

The system 100 may also include a Web service module 108 linked to the catalog 102, the context-based index module 104, and the search engine module 106. The Web service module 108 may further be connected with a network 118, e.g., the Internet, in order to provide an interface with systems operated by the sponsoring merchants in the federation. The Web service module 108 may be understood as a collection of protocols and standards used for exchanging data between the sponsoring merchants, the catalog 102, and the search engine module 106 to present the sponsoring merchant products within the marketplace window 116 of the search portal 112. The Web service 108 may also provide an interface for syndication requests received over the network 118 from a Web site of a sponsoring merchant and the resulting return of data and instructions over the network 118, including display instructions provided by a presentation layer module 110, needed to incorporate the products in a Web page display on a sponsoring merchant's Web site. The concept of syndicating the federated marketplace will be discussed in greater detail later herein.

The presentation layer module 110 interposed between the Web service module 108 and the search portal 112 may also be a component of the system 100. The presentation layer 110 may format the information about sponsoring merchant's products and services identified in the catalog 102 by the content-based index module 104 into a displayable format, e.g., a hypertext mark-up language (HTML) file. The format implemented by the presentation layer module 110 may integrate the product and service information from the catalog 102 for presentation in conjunction with the primary search results 114 on the search portal 112 or on a sponsoring merchant's Web site in the case of a syndication request. The presentation layer 110 may also incorporate any design elements specifically requested in a query to the Web service module 108, e.g., as part of a syndication request.

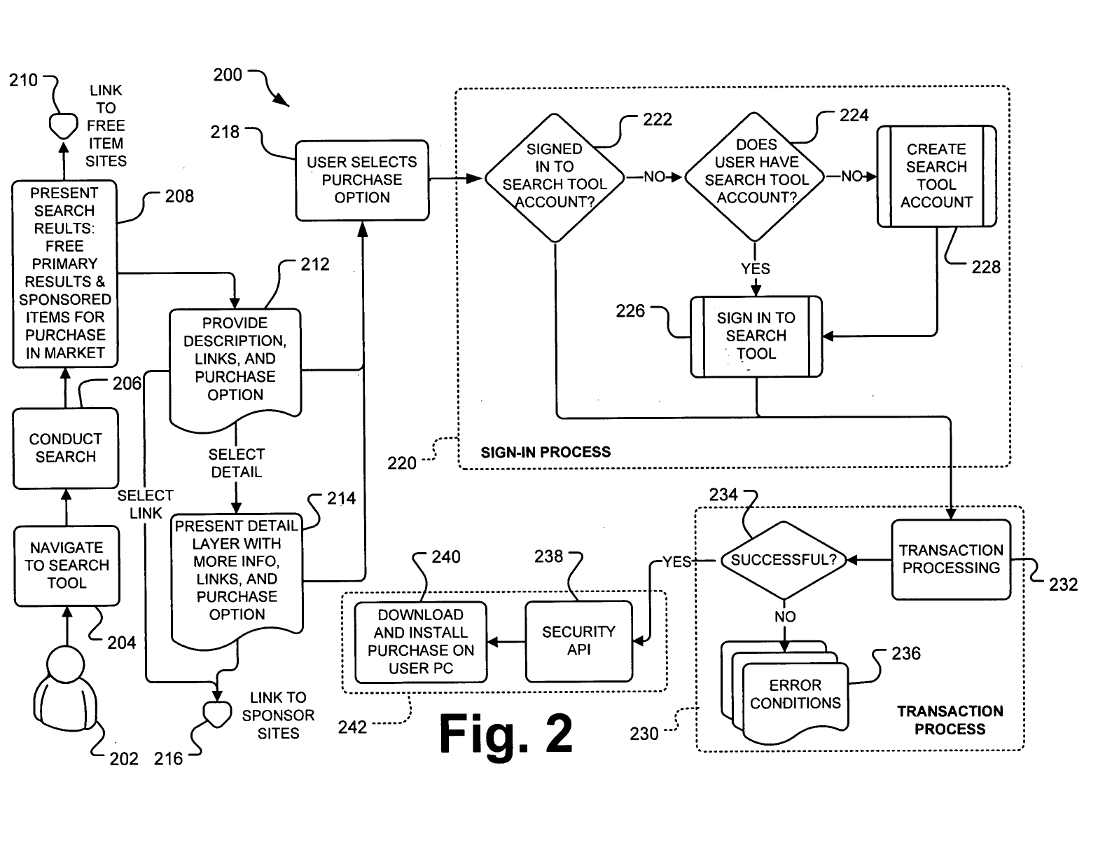

The federated marketplace is thus a context-based, distributed model that makes products and services available for purchase and possible fulfillment, e.g., a download, directly from a search portal results page. FIG. 2 depicts an exemplary implementation of a search process 200 performed by a consumer 202 on a search engine tool that provides a federated marketplace of sponsored goods and services for purchase in addition to “free” primary search results. On an initial navigation operation 204, the consumer 202 navigates to a search tool over a network, e.g., the Internet. Once connected with the search tool, the consumer 202 may enter a search query and command the search tool to conduct a search in a searching operation 206.

The search tool returns the results of the search in a presentation operation 208. The primary results of the search, i.e., the non-sponsored, “free” results with links to corresponding Web sites may be presented in one portion of the user interface display of the search results Web page presented to the consumer. Additionally, results related to sponsored products and services may be presented in a separate or designated marketplace section of the search results Web page. If a consumer decides to select one of the primary results, the consumer 202 will be redirected by a link 210 to a Web site for the selected item within the primary results.

Alternatively, in the marketplace section, brief descriptions of products and services related to the search query and offered by sponsoring merchants may be provided 212 to the consumer 202. Such descriptions may also include links to Web pages of further information, consumer ratings, and an immediate purchase option. If the consumer 202 indicates interest in a product or service of a sponsoring merchant presented in the marketplace, a previously hidden detail layer may be presented 214. The consumer indication may simply be premised on movement of a mouse cursor by the user over a specific product or service listing within the marketplace. The detail layer may include more a detailed description of a product or service offered by a particular sponsoring merchant. The detail layer may also include links to Web pages of further information, consumer ratings, and an immediate purchase option.

If the consumer 202 decides to select a link 216 to more information about a product or service provided on another Web page from either the marketplace section or a detail layer, the consumer 202 will be redirected the Web site designated by the link 216. Alternately, if the consumer 202 chooses to purchase a product or service offered by a particular sponsoring merchant from either the marketplace section generally or a detail layer in a purchase operation 218, the search portal may facilitate the purchase as part of the marketplace within the search portal without need for the consumer 202 to navigate to the sponsoring merchant's Web site.

Once the purchasing operation 218 is selected by a consumer, a sign-in process 202 may be initiated. The status of the consumer 202 may initially be investigated in a first query operation 222 to determine whether the consumer 202 is signed-in to the search tool. Such a sign-in process may be required in order to authenticate the identity of the consumer 202 and potentially make available cached information about the consumer to expedite the purchase process. For example, billing address, shipping address, and credit card information associated with a consumer 202 may be cached and accessible upon authentication of the consumer to allow “one-click” purchasing.

The sign-in process 202 may require a single authentication level or it may require several authentication steps by a consumer 202. For example, a consumer may sign-in to a Web service, e.g., Windows Live (formerly MSN Passport), that is associated with a search engine, e.g., MSN Search, and thereby be allowed to access all functions associated with that Web service during a particular session. In another example, the consumer may wish to access a premium search or information service, e.g., Microsoft Encarta, which may require a secondary log-in by the consumer.

If at the beginning of the search process 200, the consumer 202 logged on in order to use the search tool, sign-in following selection of the purchasing operation 218 may be unnecessary and the process 200 may move directly to a transaction process 232. If the consumer 202 is not already signed in, a second query operation may determine whether the consumer 202 has an account associated with the search tool. If the consumer 202 has an account, the consumer 202 will be prompted to sign in 226 to the search tool. If the consumer does not have an account, the consumer may be asked to create an account profile 228 with the search tool, e.g., by providing identification and billing information, and by selecting a password. Once an account is created, the consumer 202 will be prompted to sign in 226 to the search tool.

Again, once the consumer 202 is signed in to an account with the search tool, a transaction process 230 may take place. In a circumstance in which the consumer 202 has associated all necessary purchasing information with a search tool account for marketplace transactions, a transaction processing operation 232 may be automatic as no further information is necessary. A query operation 234 may be performed following the transaction processing operation 232 to ensure that the transaction was successful. If for some reason the transaction was unsuccessful, the transaction process 230 may identify and return any noted error conditions 236 and attempt to complete the transaction, for example by requesting missing or incomplete information from the consumer 202.

If the transaction is successful, the search process 200 may provide for immediate fulfillment of the product purchased by the consumer, for example, in the circumstance that the product is a software program or data file available for immediate download. If so, the search process 200 may implement a security application protocol interface 238 (API) to handle the downloading process. The security API may include the use of globally unique identifiers (GUID) and digital rights management (DRM) policies, e.g., if the purchase is a learning object file or a music file, in order to ensure the integrity of the file download against viruses and to ensure the compliance with any copyright or other intellectual property licenses governing the product purchased.

Finally, in a download operation 240, the product purchased by the consumer 202 may be downloaded to the consumer's computer for installation. In one implementation, the product, if a software or data file download, may be stored on the sponsoring merchant's server 242. In this implementation then the download operation 240 and the controls of the security API 238 may be conducted and applied by a server or other equipment of the sponsoring merchant rather than by the search portal operator. For other products, the sponsoring merchant may otherwise warehouse or store the products in facilities under its control for fulfillment of orders. In this way a federated marketplace is provided in that the search portal assists affiliated sponsoring merchants in securing and processing orders, while order fulfillment may ultimately be handled by the affiliated sponsoring merchants themselves. The federated marketplace thus eliminates significant cost and burden to a sponsoring merchant by providing an electronic commerce platform in which an affiliated merchant may participate, rather than having to build its own.

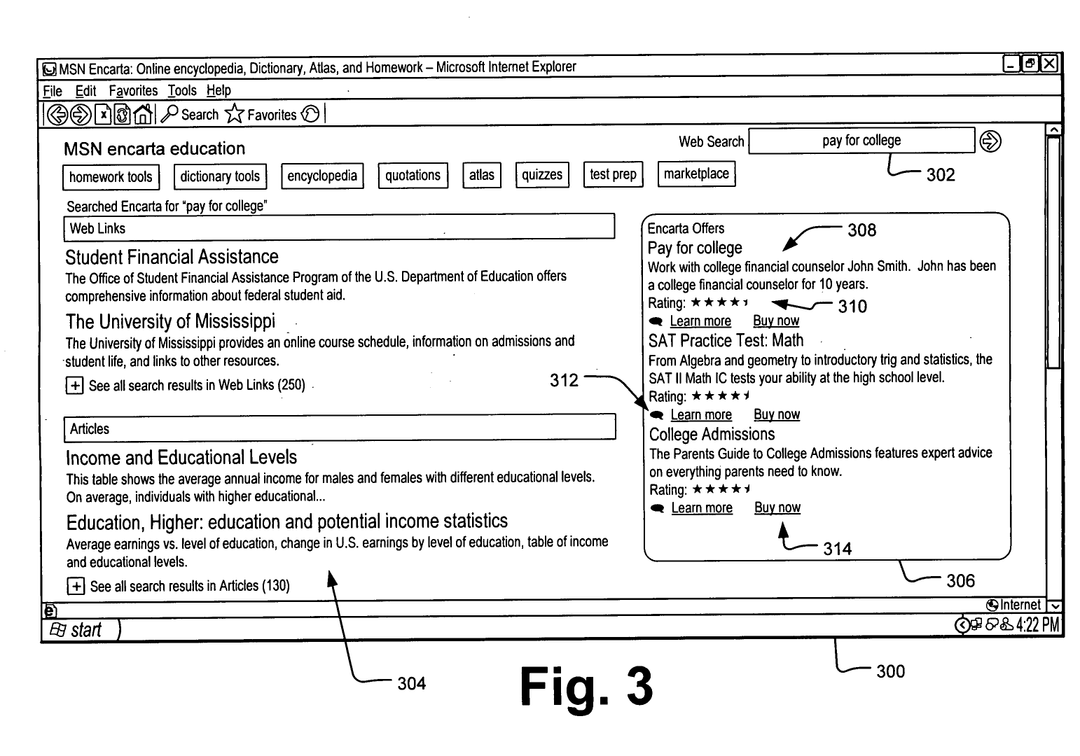

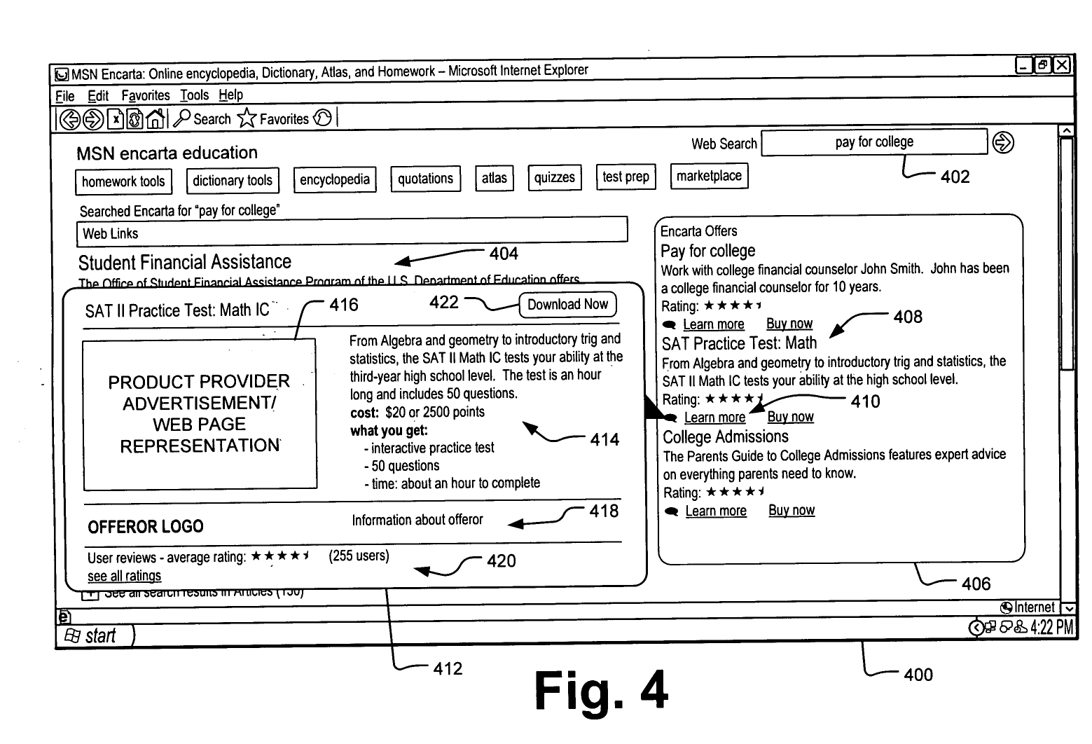

Exemplary Web pages depicting a search portal implementing the search process described with respect to FIG. 2 are shown in FIGS. 3 and 4. A search results Web page 300 for an exemplary search portal tool is depicted in FIG. 3. The search in this example is depicted as being performed using an MSN Web search function within an MSN Encarta environment. The Web search 302 in this instance queried the term “pay for college.” A list of Web links and articles were returned by the search tool and presented as primary search results 304 on the left side of the search results Web page 300.

In addition to the primary search results 304, a list of marketplace results 306 are presented on the right side of the Web page 300. These marketplace results 306 are products or services offered for purchase by sponsoring merchants selected from the catalog as related to the search terms according to the context-based index. Each result in the marketplace section 306 may include a brief description 308 of the product or service; a rating 310 provided by prior consumers purchasing the product or service; an information link 312 to learn more about the product or service offered; and a purchase link 314 that allows a consumer to immediately buy the product or service. Upon initial appearance, the marketplace search results 306 may appear similar to sponsored links in standard queries returned by known search tools. Differences between the marketplace results 306 and standard sponsored links may be better understood with reference to FIG. 4.

A search results Web page 400 for an exemplary search portal tool again querying the term “pay for college” in the search field 402 is depicted in FIG. 4. As in FIG. 3, a list of Web links and articles returned by the search tool are presented as primary search results 404 on the left side of the search results Web page 400. A list of marketplace results 406 are again presented on the right side of the Web page 400. In FIG. 4, however, a consumer has indicated a desire for additional information about the second product 408 in the marketplace listings 406. This consumer desire may be indicated by clicking the information link 410 or by merely positioning a mouse cursor over the information link 410 or an associated icon.

Upon a consumer indication for more information, a detail layer 412 may be presented within the Web page 400. The detail layer 412 may be hidden until the consumer requests more information about a particular marketplace result. The detail layer 412 may be depicted as physically associated with the selected second product 408 within the marketplace search results 406 as indicated in FIG. 4 by the expanding triangle adjacent the detail layer 412 window pointing to the icon forming part of the information link 410. By moving a cursor to select among various entries returned within the marketplace results 406, a consumer may easily comparison shop between products and services. The user could then click on the purchase link within the marketplace results window 406. Assuming the consumer was signed into his/her authenticated purchasing account, the purchasing transaction would be automatic and an immediate download of the product may commence.

As shown in FIG. 4, the detail layer 412 may include a detailed description 414 of the product or service offered by the sponsoring merchant; an advertisement or annotated Web page representation 416 providing additional information about the product or service or the sponsoring merchant; an offeror logo or other information about the sponsoring merchant, which may also provide a link to a Web site of the sponsoring merchant; and a reiteration of the rating 420 with a link to view additional ratings and comments. Additionally, the detail layer 412 may include an immediate purchase button 422, identified as “download now” in FIG. 4 as the exemplary product is a software package. Upon selection of the purchase button 422, the consumer can complete a purchase of the product as described in FIG. 2 without navigating away from the search results Web page 400, regardless of which product and corresponding sponsoring merchant is selected.

The marketplace concept exemplified in FIGS. 1-4 may be considered to provide several benefits to consumers. For example, the consumer is able to review specific products and services for purchase in context with a list of search results of the original search query. The presentation format allows for comparison shopping not possible with sponsored links. The consumer may learn detailed information about the product or service from associated Meta data that describes the product without having to navigate away from the search results. Further, because of the federated relationship between the sponsoring merchant and the search portal hosting the marketplace, there is no need to navigate to a sponsoring merchant's Web site for additional information or to make a purchase. If the product purchased is susceptible to an appropriate delivery model, the consumer may also download the desired item without leaving the search results page.

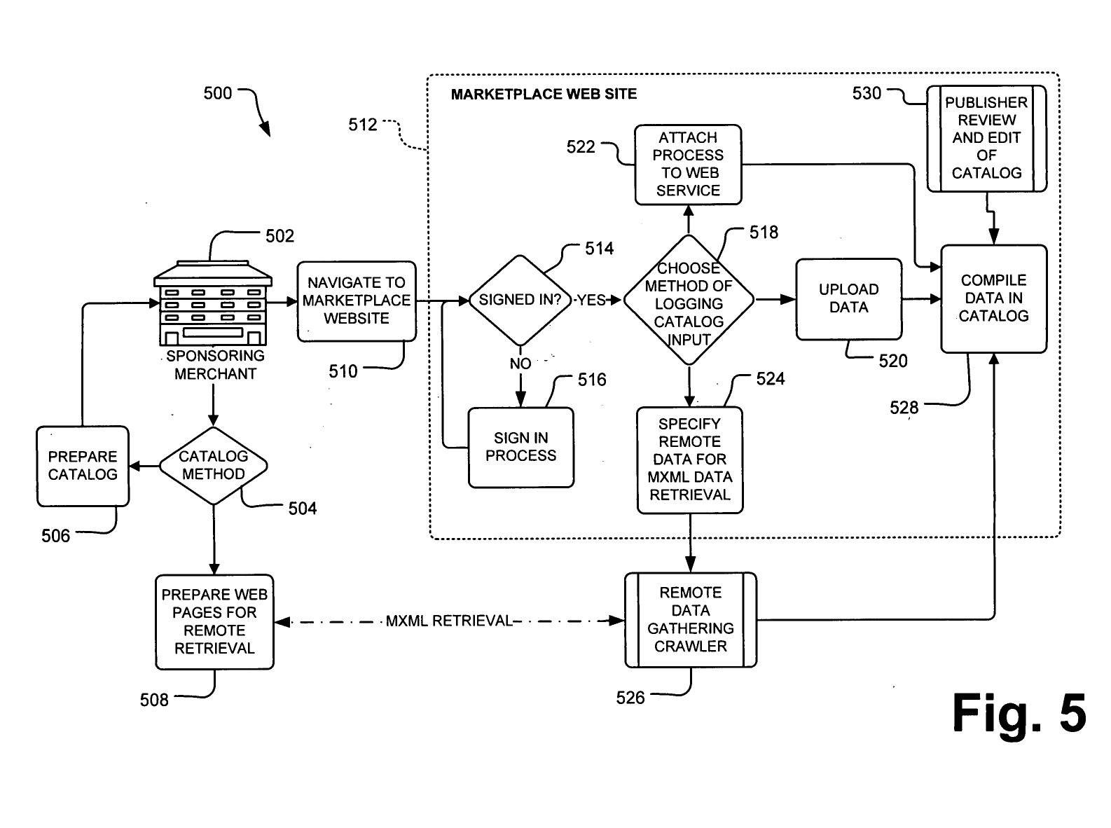

FIG. 5 depicts an exemplary implementation of a process 500 for adding product data to a catalog within a federated marketplace. Generally, sponsoring merchants that have products or services they wish to sell can make them available to the marketplace in one of several ways. In one form, the sponsoring merchant may utilize an available Web-based interface to upload Meta data about products and services via the Web service. Alternatively, the sponsoring merchant may provide a Really Simple Syndication (RSS) feed to the Web service to provide regular updates of product data. In another form, the sponsoring merchant may use a marketplace Web site with a user interface (UI) that provides for the manual input and upload of information about the products. Exemplary information collected may include title, description, and cost. The sponsoring merchant may also have the option to upload digital objects to be made available for digital download or provide a location on its own server for storage of the object and allow for retrieval of the object via an authorization process. In yet another form, a robot crawler may search the Internet for Web sites of sponsoring merchants seeking tagged product data for transfer to the search catalog for the federated marketplace.

As shown in the process 500 of FIG. 5, a sponsoring merchant 502 may choose 504 among the several methods for uploading product data to the marketplace catalog. Regardless of the chosen method, however, the sponsoring merchant will have to prepare a catalog of product data in a preparation operation 506. This data preparation may entail manually developing product descriptions for later data entry or it may involve preparing Web pages for remote retrieval, e.g., by an Internet search robot in a second preparation process 508. Once the sponsoring merchant 502 decides which cataloguing method to employ, the sponsoring merchant 502 may navigate 510 to the marketplace Web site 512 in order to register its preference for product categorizations schemes.

The marketplace Web site 512 may initially query 514 the sponsoring merchant 502 to determine whether the sponsoring merchant 502 has signed in to the Web site 512. If not, the sponsoring merchant 502 may be prompted to authenticate itself through a sign-in process 516 to ensure that any administrative functions to be performed affect the appropriate sponsoring merchant and are authorized. Once signed in to the marketplace Web site 512, the sponsoring merchant 502 is presented with a choice 518 of which method of logging catalog input is desired.

A first method may be to upload data 520, either through a manual data entry process via a UI page of the marketplace Web site 512 or through a file transfer process as described above. A second option may be to link a data transmission process, e.g., an RSS feed to the Web service in the marketplace Web site 512 as described above. A third option may be to specify remote data 524 for retrieval by the marketplace Web site 512, e.g., by identifying a URL of a Web page with Meta-tagged product data. In this case, the sponsoring merchant 502 has previously prepared Web pages in the preparation process 508 for remote retrieval of the Meta data by an Internet robot that operates as an independent data gathering crawler 526.

Whichever method for product data transfer is ultimately selected by the sponsoring merchant 502, once collected, the product data is compiled in a compiling operation 528 into the catalog. Note that while the sponsoring merchant 502 has the primary responsibility for the selection of products and corresponding descriptive data for the catalog, a publisher or marketplace administrator may have editing authority to ensure the quality of the presentation of information in the marketplace search results.

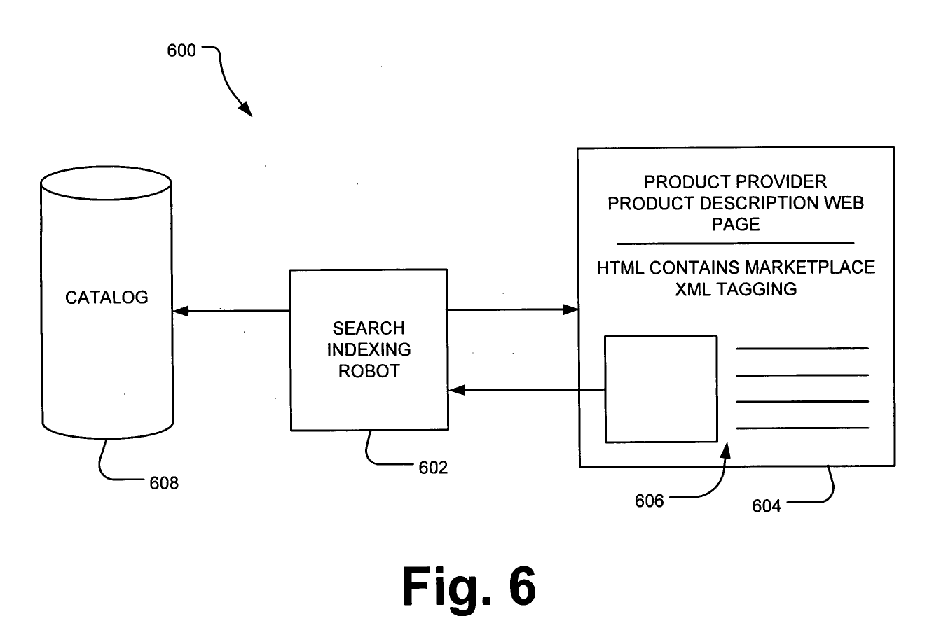

As previously referenced, in another implementation a tagging schema may used to facilitate a remote collection system 600 for product data as depicted in FIG. 6. An Internet search robot 602 may be used to collect product data 606 from a Web page 604 and provide the product data 606 to the catalog 608 storing the sponsoring merchant product data for a search portal. For example, if the sponsoring merchant operates a Web site that contains Web pages 604 with product descriptions 606, the merchant can add Meta tags to the underlying code describing the Web page 604 to identify the relevant information about the product, e.g., product descriptions and pictures, that the sponsoring merchant would like to be added to the catalog 608 at the search portal. Such tagging would be unobtrusive to the regular display of content as it appears to the consumer viewing the Web site as it would be ignored by a standard Web browser.

An exemplary tagging schema may be called “Marketplace XML Tagging” (MXT). MXT tags may be placed around the product data on the Web page 604. The sponsoring merchant may register with the search portal and submit the URL for its Web site. The Marketplace XML tags incorporated into the sponsoring merchant's Web pages 604 thus allow the Internet search robot 602 scan the identified Web site to automatically retrieve the data and index it accordingly for use in providing marketplace search results for the sponsoring merchant.

The following are exemplary marketplace XML tags that may be utilized by sponsoring merchants for implementation of a robot searching service.

<MARKETPLACE_PRODUCT_ID>ID Attribute<MARKETPLACE_PRODUCT_ID>

### A unique product identification number may appear between the opening and closing tags.

<MARKETPLACE_PRODUCT_TITLE>Title Attribute MARKETPLACE_PRODUCT_TITLE>

### A regular product title may appear between the opening and closing tags.

<MARKETPLACE_PRODUCT_DESCRIPTION>Description Attribute

</MARKETPLACE_PRODUCT_DESCRIPTION>

### A description of the product may appear between the opening and closing tags.

<MARKETPLACE_PRODUCT_IMAGE_{—}1><Image URI>

</MARKETPLACE_PRODUCT_IMAGE_{—}1>

A uniform resource locator (URL) to a product image may appear between the opening and closing tags. Tag numbering may be incremented for additional images.

<MARKETPLACE_PRODUCT_THUMBNAIL_IMAGE_{—}1><Thumbnail Image URL></MARKETPLACE_PRODUCT_THUMBNAIL_IMAGE_{—}1>

### A URL to a thumbnail product image may appear between the opening and closing tags.

<MARKETPLACE_PRODUCT_PRICE_USD>Cost Attribute

</MARKETPLACE_PRODUCT_PRICE_USD>

Text indicating the product cost in the associated currency may appear between the opening and closing tags. Additional currencies may also be supported.

The federated marketplace may thus be seen to provide several benefits to sponsoring merchants. In one respect, sponsoring merchants are conferred the ability to provide products or services to consumers without needing their own electronic commerce sites as the transactions and product display functions are handled by the marketplace. The sponsoring merchants also have the choice of storing their products on their own servers for remote retrieval by the marketplace system or on the marketplace system itself.

There is also great flexibility in the ability of sponsoring merchants to transfer product data into the marketplace catalog. Again, merchants can manually enter data into the marketplace catalog via a Web page UI or other template approach, supply a data feed, e.g., via RSS file delivery, or otherwise interfacing with Web services. Further, a schema for tagging product descriptions on a sponsoring merchant's own Web site with a unique Marketplace XML allows search robots to automatically compile product data from the Web pages for inclusion in the marketplace catalog.

In addition to tagging the contents of their Web sites, sponsoring merchants may also participate in a syndication implementation of the federated marketplace. Through syndication, the purveyor of the marketplace, e.g., a search portal, may provide sponsoring merchants with sophisticated functionality otherwise unavailable on the merchants' Web sites. Merchants using the marketplace syndication functionality can place a small amount of script on their Web page to provide search and purchasing functions for consumers visiting the Web site. The syndication script provides a search field for use by a consumer.

Once a search query is entered, the syndication script that contacts a Web service associated with the search portal. The script passes the search query to the search engine, which searches the catalog for entries associated with the sponsoring merchant. The search engine returns contextual products of the particular merchant and generates a results listing on the merchant's web page. The results may be listed inline on the merchant web page by harnessing the script to modify the HTML code on the Web page. For example, the script may recognize style sheets associated with the merchant Web page and use the defined styles to format the search results received from the search portal such that the results adopt the look and feel of the merchant's Web page.

The search results and syndication script may also be presented with a detail layer as described with respect to FIG. 4 in order to provide a consumer additional information about the product or service offered by the merchant. The Web service may also provide order processing and download services by providing appropriate interfaces to the merchant Webs site and supporting the back end functions of the commercial transactions on behalf of the merchant web site. Thus the syndication process may provide product matching, catalog, presentation, electronic commerce, and electronic software download functionalities for use on the merchant Web site through the addition of the piece of script. In this manner, a merchant may be able to provide a customer a full-service electronic commerce experience without the expense, development, and technical maintenance of a highly complicated electronic commerce capable Web site.

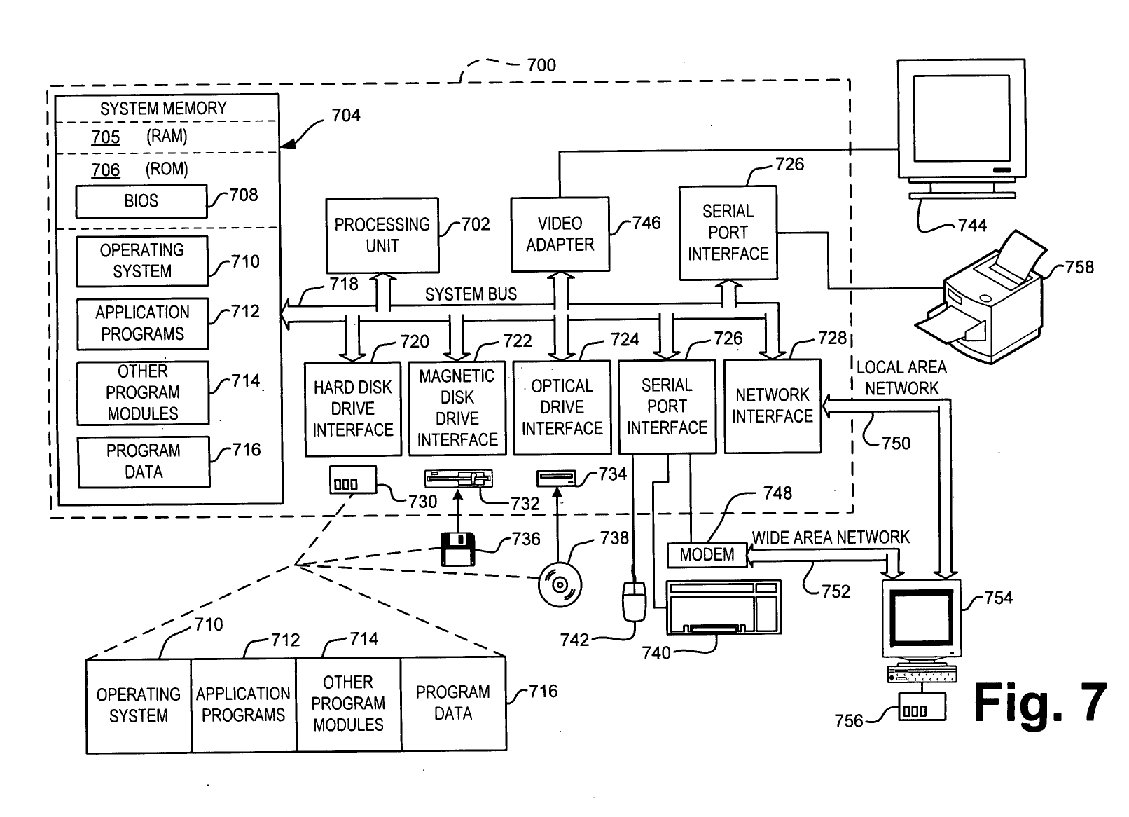

An exemplary hardware and operating environment for implementing a federated marketplace may include a general purpose computing device as shown in FIG. 7. The computing device may be in the form of a computer 700, including a processing unit 702, a system memory 704, and a system bus 718 that operatively couples various system components, including the system memory 704 to the processing unit 702. There may be only one or there may be more than one processing unit 702, such that the processor of computer 700 comprises a single central processing unit (CPU), or a plurality of processing units, commonly referred to as a parallel processing environment. The computer 700 may be a conventional computer, a distributed computer, a Web server, a file server, or any other type of computer.

The system bus 718 may be any of several types of bus structures including a memory bus or memory controller, a peripheral bus, a switched fabric, point-to-point connections, and a local bus using any of a variety of bus architectures. The system memory 704 may also be referred to as simply the memory, and includes read only memory (ROM) 706 and random access memory (RAM) 705. A basic input/output system (BIOS) 708, containing the basic routines that help to transfer information between elements within the computer 700, such as during start-up, is stored in ROM 706. The computer 700 further includes a hard disk drive 730 for reading from and writing to a hard disk, not shown, a magnetic disk drive 732 for reading from or writing to a removable magnetic disk 736, and an optical disk drive 734 for reading from or writing to a removable optical disk 738 such as a CD ROM or other optical media.

The hard disk drive 730, magnetic disk drive 732, and optical disk drive 734 are connected to the system bus 718 by a hard disk drive interface 720, a magnetic disk drive interface 722, and an optical disk drive interface 724, respectively. The drives and their associated computer-readable media provide nonvolatile storage of computer-readable instructions; data structures, e.g., a catalog and a context-based index; program modules, e.g., a Web service and an indexing robot; and other data for the computer 700. It should be appreciated by those skilled in the art that any type of computer-readable media that can store data that is accessible by a computer, for example, magnetic cassettes, flash memory cards, digital video disks, RAMs, and ROMs, may be used in the exemplary operating environment.

A number of program modules may be stored on the hard disk 730, magnetic disk 732, optical disk 734, ROM 706, or RAM 705, including an operating system 710, one or more application programs 712, other program modules 714, and program data 716. A user may enter commands and information into the personal computer 700 through input devices such as a keyboard 740 and pointing device 742, for example, a mouse. Other input devices (not shown) may include, for example, a microphone, a joystick, a game pad, a tablet, a touch screen device, a satellite dish, a scanner, a facsimile machine, and a video camera. These and other input devices are often connected to the processing unit 702 through a serial port interface 726 that is coupled to the system bus 718, but may be connected by other interfaces, such as a parallel port, game port, or a universal serial bus (USB).

A monitor 744 or other type of display device is also connected to the system bus 718 via an interface, such as a video adapter 746. In addition to the monitor 744, computers typically include other peripheral output devices, such as a printer 758 and speakers (not shown). These and other output devices are often connected to the processing unit 702 through the serial port interface 726 that is coupled to the system bus 718, but may be connected by other interfaces, such as a parallel port, game port, or a universal serial bus (USB).

The computer 700 may operate in a networked environment using logical connections to one or more remote computers, such as remote computer 754. These logical connections may be achieved by a communication device coupled to or integral with the computer 700; the invention is not limited to a particular type of communications device. The remote computer 754 may be another computer, a server, a router, a network personal computer, a client, a peer device, or other common network node, and typically includes many or all of the elements described above relative to the computer 700, although only a memory storage device 756 has been illustrated in FIG. 7. The logical connections depicted in FIG. 7 include a local-area network (LAN) 750 and a wide-area network (WAN) 752. Such networking environments are commonplace in office networks, enterprise-wide computer networks, intranets and the Internet, which are all types of networks.

When used in a LAN 750 environment, the computer 700 may be connected to the local network 750 through a network interface or adapter 728, which is one type of communications device. When used in a WAN 752 environment, the computer 700 typically includes a modem 748, a network adapter, or any other type of communications device for establishing communications over the wide area network 752. The modem 748, which may be internal or external, is connected to the system bus 718 via the serial port interface 726. In a networked environment, program modules depicted relative to the personal computer 700, or portions thereof, may be stored in a remote memory storage device. It is appreciated that the network connections shown are exemplary and other means of and communications devices for establishing a communications link between the computers may be used.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understand that the described technology may be employed independent of a personal computer. Other embodiments are therefore contemplated. It is intended that all matter contained in the above description and shown in the accompanying drawings shall be interpreted as illustrative only of particular structure may be made without departing in the following claims.

What is claimed is:

1. A method for presenting search results of products and services in context with related information contemporaneously presented to a user, the method comprising
creating a catalog of products and services offered by sponsoring merchants;
creating an index of the products and services for the catalog;
receiving a current context from the user;
determining a result set of the products and services from the catalog related to the current context; and
generating a presentation of the result set according to a presentation schema that provides an ability for a user to enter a transaction concerning one of the products and services in the result set directly with one of the sponsoring merchants without navigating away from the result set.

2. The method of claim 1 wherein the transaction comprises a commercial transaction for a purchase of one of the products or services comprising the result set.

3. The method of claim 1, wherein the transaction comprises providing detailed information about one of the products or services comprising the result set at a request of the user.

4. The method of claim 1, where in the first creating operation further comprises providing a user interface for manual entry into the catalog of data descriptive of the products and services.

5. The method of claim 1, wherein the first creating operation further comprises receiving into the catalog a structured set of data descriptive of the products and services.

6. The method of claim 1, wherein the first creating operation further comprises
reading a tag associated with the products and services to identify a set of data descriptive of the products and services; and
receiving into the catalog the set of data descriptive of the products and services.

7. The method of claim 1 further comprising transmitting a purchased product or service to the user device.

8. The method of claim 7 further comprising transmitting a request to at least one of the sponsoring merchants to fulfill an order for the purchased product or service.

9. The method of claim 2, further comprising
performing a general search for information related to the current context;
presenting results of the general search in conjunction with the presentation of the result set.

10. A computer-readable medium having computer-executable instructions for performing a computer process implementing the method of claim 1.

11. A method of cataloging products and services of a sponsoring merchant for presentation, selection, and purchase in a federated marketplace in conjunction with results of a general information search, the method comprising
identifying descriptive data in documents associated with the products and services;
uploading the descriptive data to the federated marketplace;
storing the descriptive data in a catalog within the federated marketplace; and
indexing the descriptive data in the catalog.

12. The method of claim 11, wherein the uploading operation further comprises
providing a service to interface with the catalog and a user device connected to the federated marketplace via a network; and
receiving a transmission of the descriptive data from the user device for storage in the catalog.

13. The method of claim 11 wherein the uploading operation further comprises
providing a user interface within the federated marketplace for manual input of the descriptive data; and
receiving manual input of the descriptive data in the catalog via the user interface.

14. The method of claim 11 further comprising
developing a data identification schema for identifying the descriptive data;
managing a remote robotic crawler that seeks the data identification schema in the documents; and
wherein the uploading operation further comprises receiving the descriptive data from the remote robotic crawler.

15. A computer-readable medium having computer-executable instructions for performing a computer process implementing the method of claim 11.

16. A system for providing a federated marketplace comprising
a database catalog which stores descriptive data of products and services provided by sponsoring merchants;
an index module that classifies the products and services according to keyword terms associated with respective ones of the products and services;
a search engine module for searching the catalog database for a result set of products and services related to a context of a general search initiated by a user; and
a presentation layer module that presents the result set according to a presentation schema and that provides an ability for a user to enter a transaction concerning one of the products and services in the result set directly with one of the sponsoring merchants without navigating away from the result set.

17. The system of claim 16 further comprising a service module that manages the database catalog and the search engine module to respond to a search request received over a network from the at least one of the sponsoring merchants and transmits the results set according to the presentation schema to the at least one of the sponsoring merchants over the network.

18. The system of claim 17 further comprising a remote robotic crawler that seeks identification schema identifying the descriptive data in documents generated by the sponsoring merchants accessible over a network and stores the descriptive data in the database catalog.

19. The system of claim 16, wherein
the search engine module further performs the general search for information related to the current context; and
the presentation layer further presents results of the general search in conjunction with the presentation of the result set.

20. The system of claim 17, wherein the transaction comprises a commercial transaction for a purchase of one of the products or services comprising the result set and the service module transmits a request over the network to the at least one of the sponsoring merchants to fulfill the purchase.
